(19) United States
(12) Patent Application Publication
(10) Pub. No.: US 2003/0120841 A1
(43) Pub. Date: Jun. 26, 2003

(54) System and method of data logging

(76) Inventors: Matthew C.T. Chang, Temecula, CA (US); James W. Frederick, Temecula, CA (US); Ken Johnson, Temecula, CA (US)

Correspondence Address: Pillsbury Winthrop LLP, Intellectual Property Group, Suite 1800, 101 W. Broadway, San Diego, CA, 92101-8219, US

(21) Appl. No.: 10/032,031

(22) Filed: Dec. 21, 2001

(51) Int. Cl. G06F 3/00

(52) U.S. Cl. 710/52

(57) ABSTRACT

A system and method of data logging implement a data buffer and a non-volatile data storage medium. Acquired data may be stored in the buffer temporarily until a threshold amount or volume of data has accumulated in the buffer. Buffered data may then be written to the non-volatile storage medium in large blocks, minimizing the number of write operations experienced by the non-volatile storage medium.

### FIELD OF THE INVENTION

Aspects of the present invention relate generally to data acquisition and recordation, and more particularly to a system and method of logging acquired data in a non-volatile storage medium.

### BRIEF DESCRIPTION OF THE DRAWINGS

FIG. 1 is a simplified block diagram illustrating one embodiment of a data logging system.

FIG. 2 is a simplified block diagram illustrating one embodiment of a data logging apparatus.

FIG. 3 is a flow chart illustrating the general operational flow of one embodiment of a data logging method.

### DETAILED DESCRIPTION

Embodiments of the present invention overcome various shortcomings of conventional technology, providing a data buffer for use in a data logging system and method.

In accordance with one aspect of the present invention, a system and method of data logging implement a data buffer and a non-volatile data storage medium. Acquired data may be stored in the buffer temporarily, for example, until a threshold amount or volume of data has accumulated in the buffer. Buffered data may be written to the non-volatile storage medium in large blocks, minimizing the number of write operations to the non-volatile storage medium.

The foregoing and other aspects of various embodiments of the present invention will be apparent through examination of the following detailed description thereof in conjunction with the accompanying drawings.

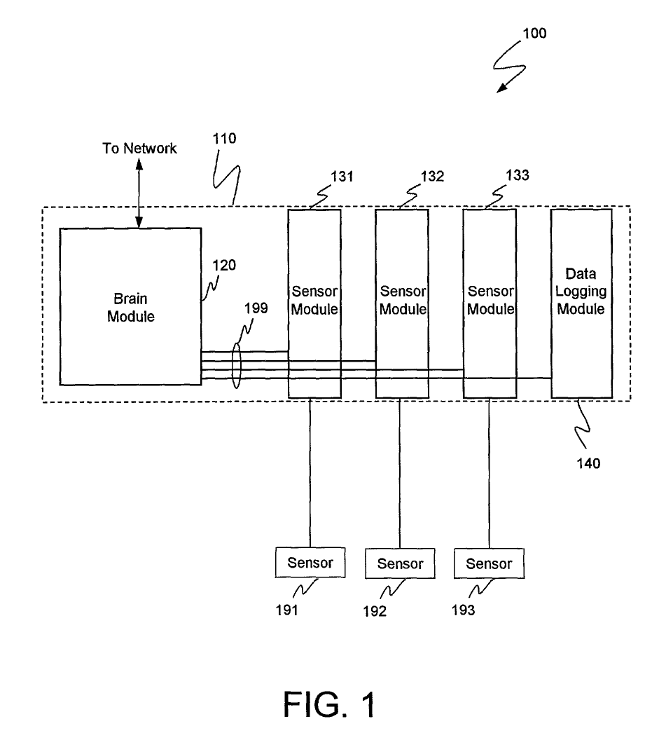

Turning now to the drawings, FIG. 1 is a simplified block diagram illustrating one embodiment of a data logging system. In the exemplary embodiment, system 100 generally comprises a housing or rack 110 accommodating and interconnecting removable modules 120-140. When constructed and operative in accordance with the FIG. 1 embodiment, system 100 may function as an input-output monitoring and data logging device.

As illustrated in FIG. 1, removable modules may include one or more of the following: a control (brain) module 120; one or more data acquisition and transmission (sensor) modules 131-133; and a data logging module 140. For clarity, only three sensor modules 131-133 and one data logging module 140 are depicted in FIG. 1. Those of skill in the art will appreciate that the FIG. 1 embodiment is presented for illustrative purposes only, and that system 100 may be implemented with any number of sensor modules and one or more additional data logging modules.

System 100 may be constructed and arranged such that insertion of a removable module 120-140 into housing or rack 110 automatically creates necessary electrical and data communication connections via a bus 199, for example, or other communication pathway. Such “plug-and-play” versatility may enable system 100 to perform different functions depending upon the number, type, and particular configuration of removable modules 120-140 coupled to rack 110. As set forth in more detail below, data communication between removable modules 120-140 may be in accordance with any protocol known in the art or developed and operative in accordance with known principles.

By way of example, sensor modules 131-133 may include suitable hardware, firmware, software, or a combination thereof operative to transmit and to receive data. As illustrated in FIG. 1, sensor modules 131-133 may generally be configured to monitor the operation of, and to receive data output from, respective sensors 191-193. Sensors 191-193 may represent any number of devices including, but not limited to, the following: thermistors, thermocouples, or other temperature measuring equipment; tachometers; speedometers; pressure gauges; fluid flow meters; gyroscopes; acoustic or other audio sensors; infrared or motion detectors; or any other similar meters, gauges, or indicators capable of generating output which may be monitored by sensor modules 131-133.

Additionally or alternatively, one or more sensor modules may be configured to transmit control signals or other desired data to remote equipment such as, for example: control modules implemented in computer hardware or software; computer-based or electronically controlled machinery; actuators; servos; hydraulic systems; electronic circuits; and any other devices to be controlled by system 100.

Brain module 120 may be any machine intelligence capable of two-way data communication with sensor modules 131-133 and data logging module 140. In the FIG. 1 embodiment, brain module 120 may additionally be capable of interfacing data received from other components of system 100 with remote equipment such as a computer or wireless device (not shown) over a network. In operation, brain module 120 may execute computer programs or instructions encoded on computer-readable media, for example, to configure sensor modules 131-133 and data logging module 140. Brain module 120 may also execute computer programs to perform control functions or otherwise to manipulate actuators or other remote devices coupled to sensor modules 131-133 as discussed above.

In that regard, brain module 120 may incorporate a microprocessor or microcontroller based microcomputer and include sufficient communications interfaces (logical and physical layers) to enable the data communication illustrated graphically in FIG. 1. One or more communications interfaces may generally be dedicated to communicating with modules 131-140, and one or more communications interfaces may generally be dedicated to communicating to other networked devices, such as equipment connected to a Local Area Network (LAN), a Wide Area Network (WAN), a Virtual Private Network (VPN), and the like. In some embodiments, brain module 120 may be implemented as a programmable logic controller (PLC).

Data logging module 140 may generally be operative to receive and to store data monitored and acquired by sensor modules 131-133. In that regard, data logging module 140 may be operatively coupled with brain module 120 via appropriate hardware and software supporting a two-way data communication link. Data logging module 140 may additionally be operatively coupled with one or more sensor modules 131-133 via a similar two-way data connection. The hardware and software components necessary to enable such communication are omitted from FIG. 1 for clarity.

In operation, data logging module 140 may receive configuration instructions from brain module 120 specifying monitor and control parameters for data logging procedures. Through such configuration, data logging module 140 may be instructed regarding which types of data are to be recorded at specified time intervals, for example, or at which data measurement levels an alarm is to be issued. Data logging module 140 may then manage data acquisition and recordation functions in accordance with such configuration instructions. It will be appreciated that data logging module 140 may acquire data either from brain module 120, from sensor modules 131-133 directly, or from a combination thereof, depending upon, for example, the specific configuration instructions received from brain module 120 and the interface between modules 120-140.

In one embodiment mentioned above, an interface between brain module 120 and the other removable modules 131-140 may be integrated, or hard-wired, into housing or rack 110 such that electrical connections and data interfaces (represented in FIG. 1 by bus 199) required for operation of, and bi-directional communication between, modules 120-140 may be made automatically upon insertion into rack 110. By way of example, the data connection may be a serial or parallel link. Alternatively, the data connection may be any type generally known in the art for communicating or transmitting data across a computer network; examples of such networking connections and protocols include, but are not limited to, Transmission Control Protocol/Internet Protocol (TCP/IP), Ethernet, Fiber Distributed Data Interface (FDDI), ARCNET, token bus or token ring networks, Universal Serial Bus (USB), and Institute of Electrical & Electronics Engineers (IEEE) 1394 (typically referred to as “FireWire”). Other types of data network interfaces and protocols, such as wireless infrared (IR) and radio frequency (RF) communications standards, are within the scope and contemplation of the present disclosure.

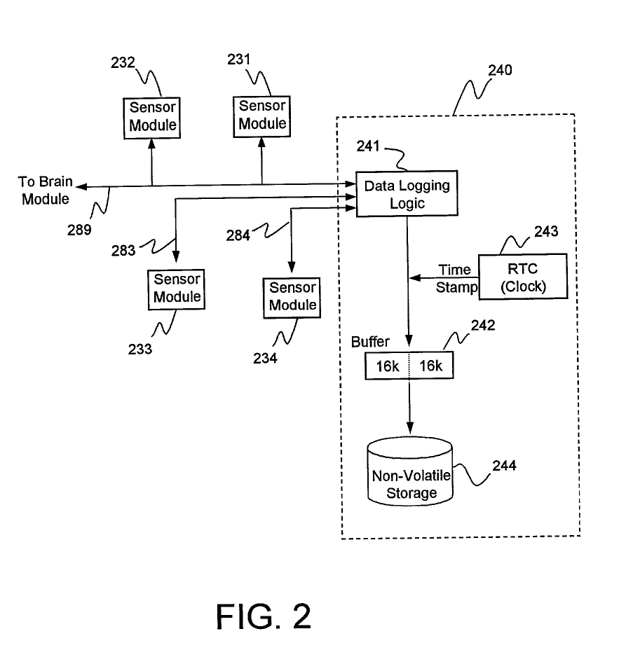

FIG. 2 is a simplified block diagram illustrating one embodiment of a data logging apparatus. Data logging module 240 corresponds generally to data logging module 140 described above with reference to FIG. 1. Data logging module 240 may include data logging logic 241, a data buffer 242, a real time clock 243, and a non-volatile data storage medium 244. As noted above with reference to FIG. 1, a data logging module 240 may include hardware and software supporting a two-way data communication link with a brain module.

Data logging logic 241 may manage all data acquisition and recordation functions in accordance with configuration instructions, for example, which may be received from a brain module. A two-way data communication link between logic 241 and a brain module is represented by a data bus 289 in FIG. 2. As discussed briefly above, logic 241 may additionally or alternatively include necessary hardware and software to support similar data communication links to one or more sensor modules 231-234. The data links may be implemented along the same data bus 289 coupling logic 241 and the brain module, or alternatively may employ one or more dedicated buses 283, 284.

Depending upon the specific system configuration and modular hardware arrangement, data acquisition may be through one or more sensor modules 233,234 directly, via respective dedicated buses 283,284, for example, or through the brain module via bus 289. Buses 283, 284, and 289 may operate in accordance with any of the network interface protocols noted above, or with other data interface technologies known in the art or operative in accordance with known principles.

Brain module may configure logic 241 to acquire specified data measurements at specified time intervals, for example, or to record the time at which a data measurement at a specified sensor module 231-234 deviates from a certain value range. The particular configuration and responsibilities of logic 241 may vary considerably, depending upon the overall arrangement and desired functionality of the system in which data logging module 240 is employed.

In a reconfigurable embodiment such as illustrated in FIG. 2, the functionality of logic 241 may be implemented in software code or programmable firmware instructions, for example, such that new configuration instructions may be accepted from the brain module via bus 289. New configuration instructions may be operative to modify the functionality of logic 241. In an alternative embodiment, some or all of the functional capabilities of logic 241 may be exclusively or primarily hardware-based, such as may be enabled through use of an integrated circuit board or programmed logic board. In this embodiment, data logging module 240 may employ predominantly dedicated data communication links such as data buses 283,284 to maintain a direct link between logic 241 and the various sensor modules 231-234.

In one embodiment, logic 241 may be constructed and implemented to be removable from data logging module 240. The general operation of data logging module 240 may be altered or improved, for example, through removal and replacement of logic 241. By way of example, logic 241 may be replaced by a different logic board or a newer version of software program code having different capabilities; accordingly, operation of data logging module 240 may be modified or improved without replacement of the entire module 240 hardware. In this embodiment, logic 241 may reside on a PLC or other dedicated integrated circuit board or chip.

The hardware arrangement of FIG. 2 accommodates one embodiment in which the brain module monitors and collects data acquired by sensor modules 231-234. Data logging logic 241 may be configured to query the brain module at specified intervals, for example, and to request transmission of collected data via bus 289. Alternatively, logic 241 may be configured to remain passive; the brain module may be responsible for transmitting collected data independent of any query or request from logic 241.

All monitored and collected data may be directed from logic 241 to data buffer 242. As an alternative, logic 241 may be configured to transmit only selected or particular data points to data buffer 242. It will be appreciated by those of skill in the art that data may be moved to buffer 242 in an unaltered state, i.e. in “raw” form. Additionally or alternatively, logic 241 may be configured to process some or all of the raw data, such as through normalization algorithms or regression procedures, for example, prior to transmission to buffer 242.

In one embodiment, data buffer 242 may be implemented as random access memory (RAM) having an associated battery or other independent (“backup”) power supply (not shown); an independent backup power supply may prevent data stored in buffer 242 from being irretrievably lost in the event of temporary power loss to data logging module 240. Data buffer 242 may selectively include sufficient storage capacity to accommodate a desired amount of data; accordingly, the capacity of buffer 242 may depend, in part, upon the desired operational characteristics of the system as a whole.

For example, where few sensor modules are employed to make infrequent measurements or otherwise to acquire relatively little data, data buffer 242 may have a 16 kilobyte (k) or 32 k capacity as illustrated in FIG. 2. Conversely, where many sensors are employed to acquire relatively voluminous data records, data buffer 242 may have a 128 Megabyte (Mb) or 256 Mb capacity. The size and format of each data record may affect the desired capacity of buffer 242.

Data logging module 240 may include one or more input/output ports or expansion slots which may accommodate, for example, removable RAM chips such as Single In-line Memory Modules (SIMMs), Dual In-line Memory Modules (DIMMs), or the like. This embodiment enables various combinations of data storage components to be inserted or removed such that the capacity of data buffer 242 may be selectively altered.

Buffer monitor circuitry or software code resident, for example, in buffer 242 itself or in logic 241, may monitor the amount or volume of data sent to data buffer 242. When such a buffer monitor (not shown) determines that the amount of data stored in data buffer 242 has reached or exceeded a predetermined threshold, the data records contained in buffer 242 may be transferred to a non-volatile data storage medium 244. The predetermined threshold may be a specified volume of data measured, for example, in bytes; similarly, the threshold may be calculated as a predetermined percentage of the total capacity of data buffer 242.

Non-volatile data storage medium 244 may be a magnetic or optical disk, a compact disk, bubble memory, flash memory, and the like as known in the art, or any other non-volatile data storage medium to which data records may be written. The present disclosure is not intended to be limited by the form or constitution of non-volatile data storage medium 244.

In one embodiment, non-volatile storage medium 244 may be removable from data logging module 240, such that storage medium 244 may be inserted into another device for data retrieval, analysis, transfer, or transmission. For example, a storage medium 244 implemented as a flash memory card or multimedia card (MMC) may be removed from data logging module 240 and inserted into a data reading device, a desktop or portable computer, a workstation, or the like, for data retrieval or analysis.

Additionally or alternatively, data may be transmitted from data logging module 240 to a remote device. Data transmission may be enabled through an output port at the brain module, for example, which may be connected to a network as described above; in another embodiment, data may be transmitted through an output port (not shown) integrated with module 240.

Those of skill in the art will appreciate that the format in which data records are written to storage medium 244 may influence the manner in which those data records may be transmitted, and vice-versa. In some embodiments, data may be stored in File Allocation Table (FAT) format, for example, and may be transmitted in accordance with File Transfer Protocol (FTP) or other data transmission protocols. Data records in FAT format are generally readable by common personal computer and workstation operating systems, for example.

Additionally or alternatively, data may be stored in various other formats including, but not limited to, Journaling Flash File System, compact flash file system formats (e.g. FlashFX), High Performance File System (HPFS), and the like. The present disclosure is not intended to be limited by the data transmission protocol employed to transmit data from module 240; in addition to FTP mentioned above, other protocols may selectively be employed as a function of the overall system environment, for instance, and other factors. For example, data may be transmitted from module 240 in accordance with Network File System (NFS) protocol, Hyper-Text Transfer Protocol (HTTP), various derivatives thereof such as HTTP Secure (HTTPS) which employs Secure Sockets Layer (SSL) technology, and other protocols known in the art or developed according to known principles.

Data may be moved from buffer 242 to non-volatile medium 244 in large blocks. In one embodiment, the entire contents of buffer 242 may be written to non-volatile medium 244 in a single write operation. The foregoing storage strategies in conjunction with buffer 242 may minimize the number of write cycles experienced by non-volatile medium 244. Temporary storage of monitored data in buffer 242 may substantially increase the useful life of non-volatile medium 244 implemented in a flash memory card, which may only be operative for a limited number of write cycles, for example.

Data logging module 240 may employ a real time clock 243, for example, to time-stamp data measurements or data write cycles. Accordingly, each data record written to non-volatile medium 244 may be provided with an associated time-stamp which may be retrieved with the data record. By way of example, a time-stamp associated with data records may enable a system administrator to evaluate the manner in which system performance varies over time or to estimate when testing or maintenance should be performed.

Though it is also possible to time-stamp acquired data after buffering, ie. as the data are written to non-volatile medium 244, the FIG. 2 embodiment illustrates data records receiving a time-stamp before the acquired data are sent to buffer 242, i.e. as the data are acquired by module 240. In some applications, the accuracy of the data record time-stamps may be critical to system diagnostic analyses or performance evaluations; additionally, the transfer of data from buffer 242 to non-volatile storage medium 244 may occur well after the data are acquired, depending upon the rate of data acquisition and the capacity of buffer 242, for example. In that regard, the FIG. 2 arrangement may be appropriate for many applications requiring accurate time-stamp information associated with every data record.

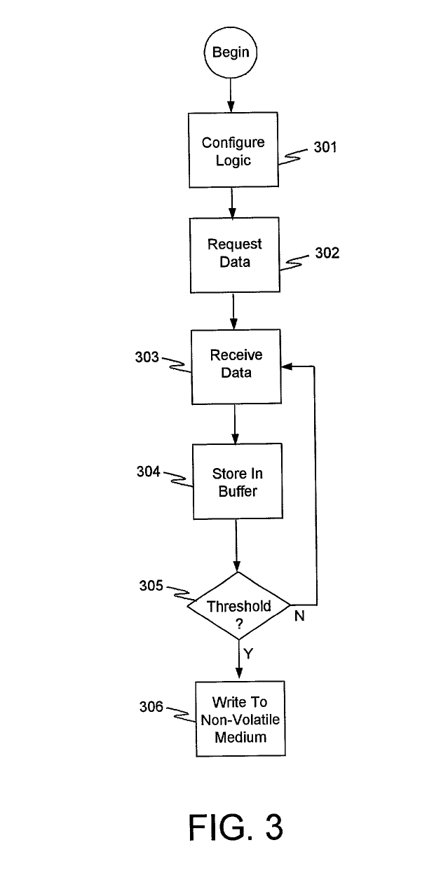

FIG. 3 is a flow chart illustrating the general operational flow of one embodiment of a data logging method. The method depicted in FIG. 3 may be enabled by a system employing a data logging module such as described in detail with reference to FIGS. 1 and 2.

As indicated at block 301, data logging logic may be configured with instructions related to operational parameters of data monitoring and recordation functions. Logic implemented in hardware which is not programmable may be hardwired (i.e. “preconfigured” during fabrication, for example) to operate in a particular fashion, whereas programmable (i.e. reconfigurable) firmware or software logic may receive configuration instructions from an external source such as a brain module as discussed above with reference to FIGS. 1 and 2.

Depending upon the configuration, data logging logic may query one or more system components (such as modules or sensors) for data records; such a request for data, indicated at block 302, may generally employ any of the system components and architecture described above with reference to FIG. 2. In an alternative embodiment, the system may be configured to transmit some or all acquired data measurements to data logging logic automatically, i.e. independent of a request.

Data measurements to be logged may be received by data logging logic as indicated at block 303. As described above, data logging logic may store received data in a data buffer (block 304). In some embodiments, instruction code resident in data logging logic may selectively execute one or more data processing or time-stamping operations before directing the received data to storage in the buffer; additionally or alternatively, any computational results derived from received data may also be stored in the buffer. For example, normalization, regression, statistical analysis, and the like, as well and any other appropriate data processing techniques, may be performed by data logging logic prior to directing data to the data buffer at block 304. Alternatively, some or all data may be stored directly into the data buffer without any processing by data logging logic, i.e. in raw form.

Data buffers generally have a limited capacity; a method of data logging may employ buffer monitor circuitry or software code as described above, for example, to monitor the amount or volume of data sent to the buffer. When such a buffer monitor determines that the content of the data buffer has reached or exceeded a predetermined threshold (a predetermined value or a predetermined percentage of total capacity, for example), data stored temporarily in the buffer, as well as associated time-stamp information, may be written to a non-volatile data storage medium as described above with reference to FIG. 2.

The decision block 305 in FIG. 3 represents the above-described determination. As indicated at block 306, if the buffer contents have reached or exceed the predetermined threshold, data in the buffer may be moved to non-volatile storage. During data logging procedures, while the data content of the buffer has not reached the predetermined threshold, however, the data logging module may continue to receive additional data for storage in the buffer, as indicated by the loop back to block 303.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the invention. Therefore, it is intended that the invention be considered as limited only by the scope of the appended claims.

What is claimed is:

1. A method of logging data; said method comprising:
acquiring data;
storing said data in a buffer;
comparing the amount of said data stored in said buffer to a predetermined threshold value; and
responsive to said comparing, writing said data to a non-volatile storage medium.

2. The method of claim 1 wherein said acquiring comprises receiving data output from one or more sensors.

3. The method of claim 1 wherein said storing comprises storing some of said data to said buffer in raw form.

4. The method of claim 1 wherein said storing comprises storing some of said data to said buffer after processing.

5. The method of claim 1 wherein said comparing comprises comparing the amount of said data stored in said buffer with a predetermined percentage of buffer capacity.

6. The method of claim 1 wherein said writing comprises writing all of said data stored in said buffer to said non-volatile storage medium in a single write operation.

7. The method of claim 1 wherein said storing comprises time-stamping said data.

8. The method of claim 1 wherein said writing comprises formatting said data in accordance with one of File Allocation Table format or a flash file system format.

9. The method of claim 1 wherein said storing comprises storing said data in a buffer comprising RAM.

10. The method of claim 1 wherein said writing comprises writing said data to a non-volatile storage medium comprising flash memory.

11. The method of claim 1 further comprising selectively repeating said acquiring, said storing, said comparing, and said writing.

12. The method of claim 1 further comprising selectively transmitting said data in said non-volatile storage medium to a remote device in accordance with one of File Transfer Protocol, Hyper-Text Transfer Protocol, or Network File System protocol.

13. The method of claim 1 wherein said acquiring, said storing, said comparing, and said writing are executed by a programmable logic controller.

14. A system of logging data; said system comprising:
data logging logic;
a buffer having data storage capacity operative to receive data from said data logging logic;
a buffer monitor operative to compare the amount of said data in said buffer with a predetermined threshold value; and
a non-volatile storage medium operative to receive said data from said buffer when the amount of said data in said buffer reaches said predetermined threshold value.

15. The system of claim 14 wherein said data logging logic is reconfigurable.

16. The system of claim 14 wherein said buffer is RAM.

17. The system of claim 16 wherein said data storage capacity of said buffer is selectively alterable.

18. The system of claim 14 wherein said non-volatile storage medium is flash memory.

19. The system of claim 18 wherein said non-volatile storage medium is removable.

20. The system of claim 14 further comprising:
an output port; and
a data interface operative to transmit said data in said non-volatile storage medium to a remote device through said output port.

21. The system of claim 20 wherein said data interface transmits said data in accordance with one of File Transfer Protocol, Hyper-Text Transfer Protocol, or Network File System protocol.

22. The system of claim 14 wherein said data logging logic is implemented in a programmable logic controller.

23. A computer readable medium encoded with data and computer executable instructions for logging data measurements; the data and instructions causing an apparatus executing the instructions to:
acquire data measurements;
store said data measurements in a buffer; and
write said data measurements to a non-volatile storage medium when the amount of said data measurements stored in said buffer reaches a predetermined threshold value.

24. The computer readable medium of claim 23 further encoded with data and instructions, further causing an apparatus to acquire said data measurements from one or more sensors.

25. The computer readable medium of claim 23 further encoded with data and instructions, further causing an apparatus to store said data measurements in said buffer in raw form.

26. The computer readable medium of claim 23 further encoded with data and instructions, further causing an apparatus to store said data measurements in said buffer after processing.

27. The computer readable medium of claim 23 further encoded with data and instructions, further causing an apparatus to write all of said data measurements stored said buffer to said non-volatile storage medium in a single write operation.

28. The computer readable medium of claim 27 further encoded with data and instructions, further causing an apparatus to format said data measurements in accordance with one of File Allocation Table format or a flash file system format.

29. The computer readable medium of claim 23 further encoded with data and instructions, further causing an apparatus to write said data measurements to flash memory.

30. A system of logging data; said system comprising:
data logging logic;
storing means for receiving data from said data logging logic and for storing said data temporarily;
comparing means for comparing the amount of said data temporarily stored in said storing means with a predetermined threshold value; and
a non-volatile storage medium operative to receive said data from said storing means when said comparing means determines that said predetermined threshold value has been reached.

31. The system of claim 30 wherein said storing means comprises RAM.

32. The system of claim 30 wherein said non-volatile storage medium is flash memory.

33. The system of claim 32 wherein said non-volatile storage medium is removable.

34. The system of claim 30 further comprising means for transmitting said data in said non-volatile storage medium to a remote device.

35. The system of claim 34 wherein said means for transmitting transmits said data in accordance with one of File Transfer Protocol, Hyper-Text Transfer Protocol, or Network File System protocol.

36. The system of claim 30 wherein said data logging logic is implemented in a programmable logic controller.
